(19) United States
(12) Patent Application Publication
(10) Pub. No.: US 2026/0286865 A1
(43) Pub. Date: Sep. 24, 2026

(54) EXHAUST DUCT OF A TURBINE TEST BENCH COMPRISING A DOUBLE TUBE

(71) Applicants: SAFRAN AIRCRAFT ENGINES, PARIS (FR); SAFRAN AERO BOOSTERS, Herstal (BE)

(72) Inventors: Caroline Marie FRANTZ, MOISSY-CRAMAYEL (FR); Bruna Manuela RAMOS, MOISSY-CRAMAYEL (FR); Benoit Femand Jose MEYS, MOISSY-CRAMAYEL (FR); Joséphine Emmeline Mary ALEXANDER, MOISSY-CRAMAYEL (FR)

(21) Appl. No.: 19/471,920

(22) PCT Filed: Apr. 3, 2024
(86) PCT No.: PCT/FR2024/050428

§ 371 Date: Oct. 2, 2025

(30) Foreign Application Priority Data
Apr. 4, 2023 (FR) FR2303354

(51) Int. Cl. F01D 25/30; G01M 15/02; G01M 15/14

(52) U.S. Cl. CPC F01D 25/30; G01M 15/02; G01M 15/14

(57) ABSTRACT

An exhaust duct of a gas-turbine test bench, including an outer tube extending along a longitudinal axis with an inlet capable of recovering the exhaust gases moved by a gas turbine. This exhaust duct include at least one inner tube which extends along a longitudinal axis with an inlet and is located inside the outer tube such that, in operation, an inner gas flow circulates in the at least one inner tube and an outer gas flow, separated from the inner flow, circulates in the outer tube outside the at least one inner tube.

### DESCRIPTION

The present invention relates to a gas-turbine test bench. More specifically, the invention relates, in such a test bench, to an exhaust duct of a gas-turbine test bench, which exhaust duct comprises an outer tube extending along a longitudinal axis, with an inlet capable of recovering the gases displaced by a gas turbine, and an outlet. In particular, the invention relates to a turbine engine test bench.

Such a test bench is described in the patent document EP 3021102. With reference to FIG. 7, which represents the prior art, the test bench comprises, from upstream to downstream (in the normal direction of air flow) an intake stack 181, a test room 182, an exhaust duct of a turbine test bench and an exhaust stack 183. The air enters the test room 182 through the vertical intake stack 181, which is open to the outside at its inlet. The test room 182 comprises a turbine engine 190 which is mounted on a thrust balance 191. Downstream of the turbine engine 190 tested, there is an exhaust duct of a test bench, which exhaust duct comprises a tube 110 which is intended to receive, at its inlet 111 (upstream end), the exhaust gases escaping from the turbine engine 190 during the testing thereof. This tube 110 is provided, at its outlet 112 (downstream end), with a spark gap 113 in the form of a cylinder, the downstream end whereof is closed by a concave cover and the side wall whereof is pierced with holes. The exhaust gases exit the spark gap through these holes and rise back into the exhaust stack 183, then escape into the atmosphere.

During the operation of the turbine engine, three air flows flowing in the test room 182 can be identified:
the primary flow (FP), which passes through the combustion chamber (HP (high pressure) core) of the turbine engine 190 and participates in combustion. At the outlet, this primary flow FP is therefore loaded with CO₂, as well as water, Sox, Nox and other particles;
the secondary flow (FS), which is compressed by the blower of the turbine engine 190 and which generates the majority of the thrust;
the induced air flow (induced flow FI), which is sucked in by the vacuum at the outlet of the turbine engine 190. More specifically, when the engine flow, which is the sum of the primary flow FP and the secondary flow FS, enters the tube 110 of the exhaust duct, it generates, by jet pump effect, a so-called “induced” flow which flows in the test room 182 without passing through the turbine engine 190.

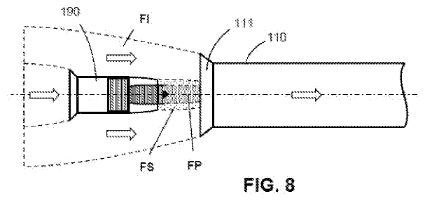

These different flows are illustrated in FIG. 8 by arrows, FIG. 8 being a longitudinal view of the turbine engine 190 and of the upstream portion of the tube 110 of FIG. 7. For the sake of clarity, the thrust balance 191 is not shown. All these flows flow in the tube 110 of the exhaust duct of a turbine test bench.

Due to combustion in the turbine engine 190, the above flows that mix and flow in the exhaust duct of a turbine test bench comprise carbon dioxide gas CO₂ that is released into the atmosphere from the outlet of the exhaust stack 183. This release of carbon dioxide is undesirable. A carbon dioxide filtration device 170 can be placed in the exhaust stack 183. However, the concentration of carbon dioxide in the flow flowing in the exhaust stack 183 is low, making such a filtration device ineffective.

### DESCRIPTION OF THE INVENTION

The present invention aims to overcome these drawbacks.

The invention aims to provide a device that contributes to making the capture of carbon dioxide gas CO₂, carbon particles and other pollutants generated by a gas-turbine test bench as efficient as possible.

This aim is achieved by the fact that the exhaust duct of the gas-turbine test bench comprises at least one inner tube extending along a longitudinal axis with an inlet and an outlet, and which is located inside the outer tube such that, during operation, an inner gas flow flows in the at least one inner tube, and an outer gas flow, separated from the inner flow, flows in the outer tube outside the at least one inner tube.

Thanks to these arrangements, a gas flow (which in this case flows in the inner tube) is obtained, which gas flow is mainly composed of the primary flow resulting from the combustion. Consequently, this gas flow has a concentration of carbon dioxide, carbon particles and pollutants that is maximized, which facilitates the depollution of this flow and makes it possible to reduce the size of the depollution system for this gas. Furthermore, this gas flow has a higher temperature than a flow flowing through the outer tube without any inner tube. The heat from this gas flow can thus be recovered more efficiently.

Advantageously, the inner tube is unique and is coaxial with the outer tube.

Advantageously, the inner tube is unique and the longitudinal axis of the inner tube is located in a vertical plane above the longitudinal axis of the outer tube and parallel to this longitudinal axis.

Advantageously, the inlet of the at least one inner tube is located downstream of the inlet of the outer tube at a longitudinal distance.

Advantageously, the at least one inner tube is attached to the outer tube by an attachment mechanism.

The assembly of the exhaust duct is thus simplified.

Advantageously, the outer tube comprises an outlet and the at least one inner tube comprises an outlet which is located downstream of the outlet of the outer tube.

Advantageously, the outer tube comprises an outlet and the at least one inner tube comprises an outlet, and the at least one inner tube comprises, upstream of its outlet and downstream of said outlet of the outer tube, a diffuser which is a duct having a cross-section that increases from upstream to downstream so as to reduce the flow speed of the gases that pass through this diffuser.

The invention further relates to an assembly consisting of an exhaust duct of a turbine test bench according to the invention, and a depollution system located downstream of the outlet of the at least one inner tube and capable of receiving the inner flow.

The invention further relates to a gas-turbine test bench comprising a building which comprises an air intake stack at a first end of the building and a gas exhaust stack at a second end of the building, a test room extending between the intake stack and the exhaust stack, a thrust balance located in the test room and capable of receiving the gas turbine for testing, and an exhaust duct of a gas-turbine test bench according to the invention, this exhaust duct being located downstream of the gas turbine when it is mounted on the thrust balance and being positioned relative to the gas turbine such that the central axis of the gas turbine passes through the at least one inner tube and such that the outer tube is capable of receiving the gas flow displaced by the gas turbine, and the test bench further comprises a depollution system which is located downstream of the outlet of the at least one inner tube and which is capable of receiving the inner flow flowing in the at least one inner tube.

Advantageously, the maximum dimension of the at least one inner tube is greater than or equal to the equivalent diameter of the ejection nozzle of the gas turbine.

The invention will be better understood and its advantages will appear more clearly upon reading the following detailed description of embodiments given as non-limiting examples. The description refers to the accompanying drawings, in which:

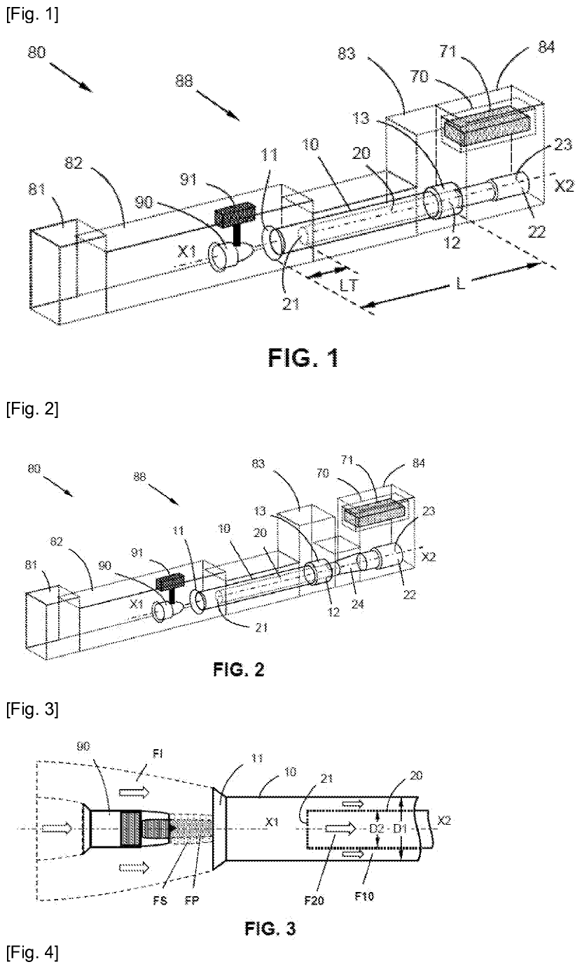

FIG. 1 is a perspective view of a turbine engine test bench according to a first embodiment of the invention.

FIG. 2 is a perspective view of a turbine engine test bench according to an alternative to the first embodiment of the invention illustrated in FIG. 1.

FIG. 3 is a side view of the upstream portion of an exhaust duct of a turbine test bench according to the invention.

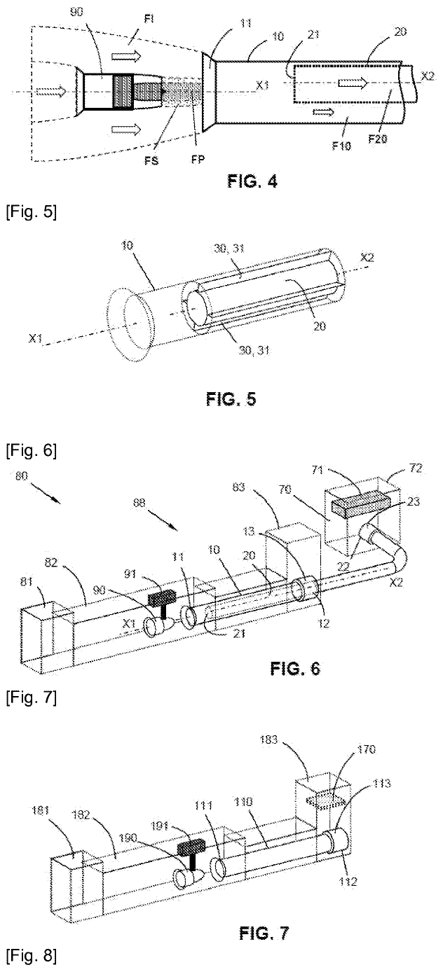

FIG. 4 is a side view of the upstream portion of an exhaust duct of a turbine test bench according to an alternative embodiment of the invention.

FIG. 5 is a perspective view of the upstream portion of an exhaust duct according to the invention, showing the attachment mechanism between the inner and outer tubes.

FIG. 6 is a perspective view of a turbine engine test bench according to a second embodiment of the invention.

FIG. 7, already described, is a perspective view of a turbine engine test bench according to the prior art.

FIG. 8, already described, is a side view of the upstream portion of the turbine engine test bench of FIG. 7.

### DETAILED DESCRIPTION OF THE INVENTION

In the description below, the terms “upstream” and “downstream” are defined with respect to the normal direction of flow of gas and air in the test bench, in the gas turbine and in the exhaust duct of a turbine test bench during normal operation of this turbine.

The invention will be described below for the case where the gas turbine 90 is a turbine engine; however, it can be applied to any gas turbine for which the displaced gas must be depolluted.

FIG. 1 shows a turbine engine test bench 90 comprising an exhaust duct of a turbine test bench (of this turbine engine) according to the invention. This test bench 80 comprises a building 88, which comprises, from upstream to downstream (in the normal direction of air flow during operation of the turbine engine 90), an intake stack 81, a test room 82 and a (first) exhaust stack 83. The air enters the test room 82 through the vertical intake stack 81, the inlet whereof opens to the outside. The test room 82 comprises a turbine engine 90 which is mounted on a thrust balance 91. Downstream of the turbine engine 90 tested lies an exhaust duct of a turbine test bench, which exhaust duct comprises a tube 10 which extends along a longitudinal axis X1 and which is intended to receive, at its inlet 11 (upstream end), the exhaust gases escaping from the turbine engine 90 during the testing thereof. The longitudinal axis X1 is substantially the longitudinal axis along which the turbine engine 90 extends. The tube 10 is provided, at its outlet 12 (downstream end), with a spark gap 13 in the form of a cylinder, the downstream end whereof is closed by a concave cover and the side wall whereof is pierced with holes. The gas flow F10 flowing in the tube 10 outside the inner tube 20 (see description below and FIG. 3) exits the spark gap 13 through these holes and rises in the exhaust stack 83, and is then released into the atmosphere. This tube 10 is referred to as the outer tube 10, as opposed to the inner tube 20 which is described below.

The exhaust duct of a turbine test bench comprises an inner tube 20 which extends along a longitudinal axis X2 with an inlet 21 and an outlet 22, and which is located inside the outer tube 10 and in the same direction.

During the operation of the turbine engine 90, three air flows flowing in the test room 82 can be identified:
the primary flow (FP), which passes through the combustion chamber (HP (high pressure) core) of the turbine engine 90 and participates in combustion. At the outlet, this primary flow FP is therefore loaded with CO₂, as well as water, Sox, Nox and other particles.
the secondary flow (FS), which is compressed by the blower of the turbine engine 90 and which generates the majority of the thrust. This secondary flow FS initially flows around the primary flow FP.
the induced air flow (FI), which is sucked in by the vacuum at the outlet of the turbine engine 90. More specifically, when the engine flow, which is the sum of the primary flow FP and the secondary flow FS, enters the outer tube 10, it generates, by jet pump effect, a so-called “induced” flow which flows in the test room 82 without passing through the turbine engine 90. This induced flow FI initially flows around the secondary flow FS.

During operation, the primary flow FP, secondary flow FS and induced flow FI enter and then flow in the outer tube 10, as illustrated in FIG. 3 by arrows. “Gas flow displaced by the turbine engine” refers to the gases and air constituting all of these primary FP, secondary FS and induced FL flows. FIG. 3 is a longitudinal view of the turbine engine 90 and of the upstream portion of the outer tube 10 and of the inner tube 20 of FIG. 1. For the sake of clarity, the thrust balance 91 is not shown.

During operation, an inner gas flow F20 flows inside the inner tube 20 and an outer gas flow F10, which is separate from the inner flow F20, flows in the outer tube 10 outside the inner tube 20.

The outer tube 10 and the inner tube 20 are coaxial, as illustrated in FIGS. 1 and 2 (as well as in FIGS. 3, 5 and 6). The longitudinal axes X1 and X2 are therefore coincident. The outer tube 10 and the inner tube 20 are concentric.

Thanks to its central position in the space within the outer tube 10, the inner tube 20 preferably receives the gas flow that is most central, i.e. that is the closest to the longitudinal axis X1. Thus, the inner flow F20 consists of the majority, or even of almost all, of the primary flow FP, and of part of the secondary flow FS. The outer flow F10 consists of the remainder of the secondary flow FS and of almost all of the induced flow FI. For example, the outer flow F10 consists of the majority of the secondary flow FS and of all of the induced flow Fl.

The tests carried out by the inventors show that up to 92% of the primary flow FP can be captured in the inner tube 20. Given that the primary flow FP is the one of the three flows (FP, FS, FI) which is by far the most loaded with carbon dioxide gas, carbon particles and other pollutants, it is possible, thanks to the invention, to increase the concentration of carbon dioxide gas, carbon particles and other pollutants in the flow treated by the filtration system (depollution device) 70 located downstream of the inner tube 10 (see below), compared with the flow flowing in an exhaust duct without any inner tube 20.

Conversely, the flow of gas F10 flowing in the tube 10 outside the inner tube 20 and which exits the spark gap 13 and then rises into the exhaust stack 83 is very low in pollutants (even less than in the flow flowing in the exhaust duct without any inner tube 20). It is therefore possible to allow this gas flow F10 to escape through the extraction stack 83 without filtering/treating it.

As an alternative to the configuration wherein the outer tube 10 and the inner tube 20 are coaxial, the longitudinal axis X2 of the inner tube 20 is located in a vertical plane above the longitudinal axis X1 of the outer tube 10 and parallel to this longitudinal axis X1. In other words, the inner tube 20 is translated in a vertical plane (containing the longitudinal axis X1) relative to the position wherein the outer tube 10 and the inner tube 20 are concentric. This configuration is shown in FIG. 4. This configuration has the advantage that more gases from the combustion are captured in the inner tube 20 since the natural discharge path for the gases from the turbine engine 90 can be upwards.

The longitudinal central axis of the turbine engine 90 extends in the same direction as the longitudinal axis X1 and the longitudinal axis X2. In all cases, the turbine engine 90 is positioned relative to the inner tube 20 such that this central axis of the turbine engine 90 passes in the inner tube 20 (and extends in the same direction as the inner tube 20).

In all cases, the maximum dimension D2 of the inner tube 20 is strictly less than the maximum dimension D1 of the outer tube 10. For example, the maximum dimension D2 is less than or equal to half the maximum dimension D1. In the case where the inner tube 20 and the outer tube 10 are of circular cross-section (their cross-section is a circle) as illustrated in all figures, the maximum dimensions D1 and D2 are the diameters of these circles. The diameters D1 and D2 are shown in FIG. 3.

Alternatively, the inner tube 20 and the outer tube 10 each have an elliptical cross-section. Alternatively, the inner tube 20 and the outer tube 10 each have a polygonal cross-section, for example in the shape of a square or a rectangle.

According to an alternative embodiment (not shown), the inner tube 20 is divided transversely, i.e. by a wall that extends along the longitudinal axis X2, over all or part of its length.

According to an alternative embodiment (not shown), the outer tube 10 is divided transversely into two half-tubes by a wall that extends over its entire length, along the longitudinal axis X1. In this alternative embodiment, the inner tube 20 is, for example, formed by one of these half-tubes, or for example is housed inside one of these half-tubes.

According to an alternative embodiment, the maximum dimension D2 of the inner tube 20 is greater than or equal to the diameter of the primary flow FP which is emitted by the combustion chamber of the turbine engine 90, measured immediately at the outlet of this combustion chamber. In other words, the maximum dimension D2 is greater than or equal to the equivalent diameter of the ejection nozzle of the turbine engine 90. Thus, all or almost all of the primary flow FP passes through the inner tube 20.

As illustrated in FIG. 1, the inlet 21 of the inner tube 20 is located downstream of the inlet 11 of the outer tube 10 at a longitudinal distance LT. This longitudinal distance LT is therefore not zero.

For example, the longitudinal distance LT between the inlets (11, 21) is less than half the length L of the outer tube 10 (see FIG. 1). For example, the longitudinal distance LT is preferably greater than 0.8 times the maximum dimension D1 of the outer tube 10.

Alternatively, the inlet 21 of the inner tube 20 and the inlet 11 of the outer tube 10 are located in the same transverse plane (relative to the longitudinal axis X1).

The inner tube 20 is attached to the outer tube 10 by an attachment mechanism 30. For example, this attachment mechanism 30 consists of a plurality of radial fins 31 that are evenly distributed along the circumference of the inner tube 20 in the space between the inner tube 20 and the outer tube 10. Each fin 31 extends longitudinally in the direction of the longitudinal axis X2. For example, the number of fins is equal to four, as illustrated in FIG. 5 in the case where the inner tube 20 and the outer tube 10 are coaxial. Alternatively, the attachment mechanism consists of a plurality of radial rods that are distributed in the space between the inner tube 20 and the outer tube 10 along the inner tube 20 in several transverse planes, and evenly distributed, in each transverse plane, along the circumference of the inner tube 20.

The outlet 22 of the inner tube 20 is located downstream of the outlet 12 of the outer tube 10. Thus, the inner tube 20 extends downstream of the outer tube 10 with a constant cross-section, as illustrated in FIG. 1.

Advantageously, the inner tube 20 is provided, at its outlet 22, with a spark gap 23 in the form of a cylinder, the downstream end whereof is closed by a concave cover and the side wall whereof is pierced with holes. The inner flow F20 exits the spark gap 23 through these holes and rises up into a second exhaust stack 84 which encompasses the outlet 22 and the spark gap 23. The second exhaust stack 84 is part of the building 88, as illustrated in FIG. 1 (or in FIG. 2, which shows an alternative to the embodiment of FIG. 1, described below).

The invention further relates to an assembly consisting of an exhaust duct of a turbine test bench as described above, and a depollution system 70 which is located downstream of the outlet 22 of the inner tube 20 and which is capable of receiving the inner flow F20 flowing in the inner tube 20. The depollution system 70 comprises a depollution filter 71. The depollution system 70 is located in the second exhaust stack 84, for example directly above the spark gap 23, as illustrated in FIG. 1 (or FIG. 2). Thanks to its filter, this depollution system 70 is able to capture the carbon dioxide gas CO2, the carbon particles and the other polluting particles that are in the inner flow F20 such that, downstream of the depollution system 70, the gas of the inner flow F20 is depolluted by this depollution filter 71. This depollution process is made more efficient thanks to the higher density of the carbon dioxide CO2, carbon particles and other pollutant particles that are in the inner flow F20 (this density is higher than if the inner tube 20 was absent).

According to a first embodiment, described above with reference to FIG. 1, the depollution system 70 is part of the test bench 80 and the building 88.

In this first embodiment, according to an alternative thereto, the inner tube 20 comprises, upstream of its outlet 22 and downstream of the outlet 12 of the outer tube 10, a diffuser 24 which is a duct, for example a conical duct, the cross-section whereof increases from upstream to downstream. Thus, the flow rate of the gases passing through this diffuser 24 is reduced, which makes it possible to increase the quantity of gas captured and the pressure drop available for the depollution system 70 positioned downstream of the spark gap 23. This situation is illustrated in FIG. 2.

According to a second embodiment, the depollution system 70 is part of the test bench 80 and is not part of the building 88. The depollution system 70 thus comprises a depollution building 72, which is separate from the building 88, and which contains the depollution filter 71, and the outlet of the inner tube 20 is located in this depollution building 72 such that the inner flow F20 passes through this filter 71.

In this second embodiment, according to a first alternative thereto (not illustrated), the depollution system 70 is positioned remotely from the building 88 and remains in the main direction of the building (from the intake stack 81 to the first exhaust stack 83). Thus, the inner tube 20 extends along the longitudinal axis X2 outside the building 88 as far as this depollution system 70. The outlet 22 of the inner tube 20 is either provided with a spark gap 23, or devoid of this spark gap 23 (in this case the outlet 22 is provided with at least one orifice through which the gas exits into the depollution building 72).

In this second embodiment, according to a second alternative thereto illustrated in FIG. 6, the depollution system 70 is offset relative to the building 88. Thus, the inner tube 20 extends in a curved manner (extending away from the longitudinal axis X2), outside the building 88 as far as this depollution system 70. The outlet 22 of the inner tube 20 is either provided with a spark gap 23 or devoid of this spark gap 23. FIG. 6 illustrates the case where the outlet of the inner tube 20 is provided with a spark gap 23.

An exhaust duct of a turbine test bench 90 according to the invention makes it possible to obtain a gas flow at a higher temperature than in an exhaust duct according to the prior art. More specifically, the inner flow F20 flowing in the inner duct 20 is essentially composed of the primary flow FP, which exits directly from the combustion chamber of the turbine engine 90 and which is therefore at a higher temperature than the secondary flow FS and the induced flow FL. Thus, the inner flow F20 has a higher temperature than the outer flow F10 flowing in the outer tube 10 outside the inner tube 20, and a higher temperature than a flow flowing in the outer tube without any inner tube in the prior art. Advantageously, the inner duct 20 is placed in thermal communication with a heat exchanger (not shown) which is able to recover this heat for a given application. This heat exchanger works more efficiently because the inner flow F20 is at a higher temperature. The tests carried out by the inventors show that, in the inner tube 20, it is possible to increase the temperature of the recovered flow by 50° C. (compared with an exhaust duct without any inner tube 20).

The invention further relates to a test bench 80 of a gas turbine 90 with an exhaust duct of a turbine test bench and a depollution system 70 as described above.

Thus, the test bench 80 of the gas turbine 90 comprises a building 88 comprising an air intake stack 81 at a first end of the building and at least one gas exhaust stack 83, 84 at a second end of the building, a test room 82 extending between the intake stack 81 and the exhaust stack 83, 84, a thrust balance 91 located in the test room 82 and capable of receiving the turbine engine 90 for testing, an exhaust duct of a turbine test bench which is located downstream of the turbine engine 90 when it is mounted on the thrust balance 91 and which is positioned relative to the turbine engine such that the central axis of the turbine engine passes in the inner tube 20 of the exhaust duct and such that the outer tube 10 is capable of receiving the gas flow displaced by the turbine engine. The test bench 80 further comprises a depollution system 70 which is located downstream of the outlet 22 of the inner tube 20 and which is capable of receiving the inner flow F20 flowing in the inner tube 20. According to one configuration, the building 88 comprises a single exhaust stack 83, and the depollution system 70 is located outside this building 88, and is adjacent thereto, offset along the axis thereof, or offset from the main direction of this building. According to another configuration, the building comprises a (first) exhaust stack 83 and a second exhaust stack 84, and the depollution system 70 is located in this second exhaust stack 84.

The invention has been described above in the configuration wherein the exhaust duct comprises a single inner tube 20. Alternatively, in another configuration, the exhaust duct comprises two or more inner tubes 20 which are parallel to one another and which are located inside the outer tube 10. In a first alternative to this configuration, these inner tubes 20 are arranged side by side, i.e. each inner tube 20 has a longitudinal axis X2 that is parallel and separate from the longitudinal axes X2 of the other inner tubes 20. For example, these inner tubes 20 all have the same diameter. In a second alternative to this configuration, these inner tubes 20 are concentric. In other words, these inner tubes 20 are coaxial, i.e. the longitudinal axes X2 of all these tubes are aligned. The diameters D2 of any two inner tubes 20 must therefore be different.

The invention has been described above in the case where the turbine engine is a twin-spool turbofan. The invention also applies to a test bench of any type of turbine engine such as a turbojet, a three-spool turbofan, a turboshaft, or a military engine.

What is claimed is:

1. An exhaust duct of a gas-turbine test bench comprising an outer tube extending along a longitudinal axis with an inlet capable of recovering the gases displaced by a gas turbine said exhaust duct comprising at least one inner tube extending along a longitudinal axis with an inlet and which is located inside said outer tube such that, during operation, an inner gas flow flows inside said at least one inner tube and an outer gas flow, which is separate from said inner flow flows, in said outer tube outside said at least one inner tube.

2. The exhaust duct of a gas-turbine test bench according to claim 1, wherein said inner tube is unique and is coaxial with said outer tube

3. The exhaust duct of a gas-turbine test bench according to claim 1, wherein said inner tube is unique and the longitudinal axis of said inner tube is located in a vertical plane above the longitudinal axis of said outer tube and parallel to this longitudinal axis.

4. The exhaust duct of a gas-turbine test bench according to claim 1, wherein said inlet of the at least one inner tube is located downstream of said inlet of the outer tube at a longitudinal distance.

5. The exhaust duct of a gas-turbine test bench according to claim 1 such that said at least one inner tube is attached to the outer tube by an attachment mechanism.

6. The exhaust duct of a gas-turbine test bench according to claim 1, wherein said outer tube comprises an outlet and said at least one inner tube comprises an outlet which is located downstream of the outlet of said outer tube.

7. The exhaust duct of a gas-turbine test bench according to claim 1, wherein said outer tube comprises an outlet and said at least one inner tube comprises an outlet, and wherein said at least one inner tube comprises, upstream of its outlet and downstream of said outlet of the outer tube, a diffuser which is a duct whose cross-section increases from upstream to downstream so as to reduce the flow rate of the gases passing through this diffuser.

8. An assembly consisting of an exhaust duct of a gas-turbine test bench according to claim 1, and a depollution system located downstream of said outlet of said at least one inner tube and capable of receiving said inner flow.

9. A test bench of a gas turbine comprising a building which comprises an air intake stack at a first end of the building and a gas exhaust stack at a second end of the building, a test room extending between the intake stack and the exhaust stack, a thrust balance located in said test room and capable of receiving said gas turbine for testing, and an exhaust duct of a gas-turbine test bench according to claim 1, said exhaust duct being located downstream of said gas turbine when it is mounted on said thrust balance and being positioned relative to said gas turbine such that the central axis of said gas turbine passes through said at least one inner tube and such that said outer tube is capable of receiving the gas flow displaced by said gas turbine, and said test bench further comprises a depollution system which is located downstream of the outlet of said at least one inner tube and which is capable of receiving said inner flow flowing in said at least one inner tube.

10. The test bench of a gas turbine according to claim 9, wherein the maximum dimension of said at least one inner tube is greater than or equal to the equivalent diameter of the ejection nozzle of said gas turbine.
